(19) United States
(12) Patent Application Publication
(10) Pub. No.: US 2025/0363470 A1
(43) Pub. Date: Nov. 27, 2025

(54) BLOCKCHAIN-BASED TRANSACTION MANAGEMENT METHOD AND APPARATUS, COMPUTER, AND STORAGE MEDIUM

(71) Applicant: TENCENT TECHNOLOGY (SHENZHEN) COMPANY LIMITED, Shenzhen (CN)

(72) Inventor: Qucheng LIU, Shenzhen (CN)

(21) Appl. No.: 19/292,372

(22) Filed: Aug. 6, 2025

Related U.S. Application Data
(63) Continuation of application No. PCT/CN2023/132382, filed on Nov. 17, 2023.

(30) Foreign Application Priority Data
Jun. 26, 2023 (CN) 202310763341.3

(51) Int. Cl. G06Q 20/06; H04L 9/00

(52) U.S. Cl. CPC G06Q 20/06; H04L 9/50

(57) ABSTRACT

A blockchain-based transaction management method includes obtaining transaction data, generating a Merkle management tree based at least on the transaction data, invoking a privacy contract based on privacy transaction data in the transaction data, verifying a data execution state of the privacy transaction data through the privacy contract, generating a transaction block based on the Merkle management tree and the transaction data, and performing on-chain processing on the transaction block.

### CROSS-REFERENCE TO RELATED APPLICATIONS

This application is a continuation of International Application No. PCT/CN2023/132382, filed on Nov. 17, 2023, which claims priority to Chinese Patent Application No. 202310763341.3, filed with the China National Intellectual Property Administration on Jun. 26, 2023 and entitled “BLOCKCHAIN-BASED TRANSACTION MANAGEMENT METHOD AND APPARATUS, COMPUTER, AND STORAGE MEDIUM,” the entire contents of both of which are incorporated herein by reference.

### FIELD OF THE TECHNOLOGY

This application relates to the field of computer technologies, and in particular, to a blockchain-based transaction management method and apparatus, a computer, and a storage medium.

### BACKGROUND OF THE DISCLOSURE

Devices often engage in two types of transactions: regular transactions that can be executed by a plurality of blockchain nodes, and privacy transactions that are executed by a single blockchain node. Privacy transactions can only be executed by a single blockchain node, i.e., characteristics of the two types of transactions are different. Therefore, two systems are generally built. One system performs off-chain collaboration through a dedicated line to implement off-chain tasks to execute privacy transactions, enabling more secure and efficient collaboration through a private network connection. The other system is configured for on-chain interaction to implement off-chain tasks, enabling more convenient data sharing and interaction and better data traceability. However, building of the systems increases the complexity of the system architecture and also increases the development workload. In addition, there are more application interfaces between mechanisms, and more network ports are opened, which increases the complexity of operation and maintenance, making transaction management more complex and less efficient.

### SUMMARY

In accordance with the disclosure, there is provided a blockchain-based transaction management method including obtaining transaction data, generating a Merkle management tree based at least on the transaction data, invoking a privacy contract based on privacy transaction data in the transaction data, verifying a data execution state of the privacy transaction data through the privacy contract, generating a transaction block based on the Merkle management tree and the transaction data, and performing on-chain processing on the transaction block.

Also in accordance with the disclosure, there is provided a computer device including a processor, and a memory storing a computer program that, when executed by the processor, causes the computer device to obtain transaction data, generate a Merkle management tree based at least on the transaction data, invoke a privacy contract based on privacy transaction data in the transaction data, verify a data execution state of the privacy transaction data through the privacy contract, generate a transaction block based on the Merkle management tree and the transaction data, and perform on-chain processing on the transaction block.

Also in accordance with the disclosure, there is provided a non-transitory computer-readable storage medium storing a computer program that, when executed by a processor, causes a computer device including the processor to obtain transaction data, generate a Merkle management tree based at least on the transaction data, invoke a privacy contract based on privacy transaction data in the transaction data, verify a data execution state of the privacy transaction data through the privacy contract, generate a transaction block based on the Merkle management tree and the transaction data, and perform on-chain processing on the transaction block.

### BRIEF DESCRIPTION OF THE DRAWINGS

To describe technical solutions in embodiments of this application more clearly, the following briefly describes accompanying drawings needed for describing the embodiments. Apparently, the accompanying drawings in the following descriptions show merely some embodiments of this application, and a person of ordinary skill in the art may still derive other drawings from these accompanying drawings without creative efforts.

FIG. 1 is a schematic architectural diagram of a blockchain system according to an embodiment of this application.

FIG. 2 is a schematic diagram showing a transaction management scenario according to an embodiment of this application.

FIG. 3 is a flowchart of a blockchain-based transaction management method according to an embodiment of this application.

FIG. 4 is a schematic diagram showing a tree-shaped construction scenario according to an embodiment of this application.

FIG. 5 is a schematic diagram showing world state tree data according to an embodiment of this application.

FIG. 6 is a flowchart showing exemplary transaction management according to an embodiment of this application.

FIG. 7 is a schematic flowchart showing contract deployment according to an embodiment of this application.

FIG. 8 is a schematic flowchart showing account registration according to an embodiment of this application.

FIG. 9 is a schematic flowchart showing contract invocation according to an embodiment of this application.

FIG. 10 is a schematic diagram of a blockchain-based transaction management apparatus according to an embodiment of this application.

FIG. 11 is a schematic structural diagram of a computer device according to an embodiment of this application.

### DESCRIPTION OF EMBODIMENTS

The following describes the technical solutions in the embodiments of this application with reference to the accompanying drawings in the embodiments of this application. Apparently, the described embodiments are merely some but not all of the embodiments of this application. All other embodiments obtained by a person of ordinary skill in the art based on the embodiments of this application without creative efforts shall fall within the scope of this application.

If data of an object (for example, a user) needs to be collected in this application, a prompt interface or a pop-up window is displayed before the collection or during the collection. The prompt interface or the pop-up window is configured to notify the user that some data such as transaction data is being collected. An operation related to data obtaining starts only after a confirmation operation sent by the user to the prompt interface or the pop-up window is obtained; otherwise the process ends. In addition, the user data obtained will be used in reasonable and legal scenarios or purposes. In some embodiments, in some scenarios in which the user data are needed but user authorization has not been obtained, a request for authorization may be made to the user, and the user data may be used when the authorization is granted. The use of the user data complies with relevant laws and regulations.

Some terms involved in this application are described below.

1. Merkle tree: It is also referred to as a hash tree, and is a data structure with a tree structure. It may be used to verify the integrity and consistency of a large amount of data, and is widely used. The Merkle tree is formed by a hash function and leaf nodes, and each leaf node represents a data block. A series of hash values are obtained through hash operation performed on each data block. The hash values are matched in pairs, and then hash operation is performed on the hash values, to obtain new hash values, referred to as parent nodes. The process is continuously repeated until a root node, namely, a root hash value of the Merkle tree, is obtained.

A main function of the Merkle tree is to verify the integrity and consistency of data. When a number of data blocks is large, verifying all data is costly. However, the Merkle tree may divide the large amount of data into a plurality of blocks, perform hash operation on each block, and use the hash values to form one tree structure, thereby reducing verification costs. When a data block needs to be verified, it is sufficient to verify whether a hash value of the data block matches a hash value of a parent node. If there is a mismatch, it indicates that the data block or the parent node has been tampered with, resulting in incomplete or inconsistent data. This verification manner is referred to as a Merkle proof.

The Merkle tree is widely used to verify the correctness of transaction data. Each transaction includes an input and an output of the transaction, and other information of the transaction. Hash operation is performed on the information through the hash function, to obtain a hash value of the transaction. Hash values of all transactions are then used to form one Merkle tree, and a root hash value of the tree is recorded in a block header. In this way, when one block is broadcast into a network, other nodes may verify the correctness and consistency of transaction data by verifying the Merkle root hash value in the block header. If the transaction data is tampered with, the Merkle root hash value also changes, making verification impossible. This ensures the security and reliability of the transaction data.

2. Digital signature: It is a technology configured for ensuring the authenticity, integrity, and non-repudiation of digital documents (for example, e-mails, electronic contracts, or software). A process for the digital signature includes the following several operations.
(1) Message digest creation: Raw data is processed by using a hash function to generate a message digest, which is configured for ensuring the integrity of the data.
(2) Private key encryption: A creator uses a private key of the creator to encrypt the message digest, to generate the digital signature.
(3) Public key decryption: A receiver uses a public key of the creator to decrypt the digital signature, to obtain the message digest.
(4) Digest verification: The receiver generates a message digest for the original data by using the same hash function, and compares the message digest with the decrypted digest, to verify the integrity of the data.

If verification on the digital signature succeeds, the receiver can trust the authenticity and integrity of the original data, and the creator cannot deny the source and content of the data. The digital signature technology is widely used in fields such as e-commerce, digital certificates, and digital rights management. Each signature involved in this application may be considered as a digital signature, for example, a transaction parameter signature or a contract signature.

3. A blockchain is a new application mode of computer technologies such as distributed data storage, peer-to-peer transmission, a consensus mechanism, and an encryption algorithm. The blockchain is essentially a decentralized database and is a string of data blocks generated through association by using a cryptographic method. Each data block includes information of a batch of network transactions, the information being configured for verifying the validity of information of the data block (anti-counterfeiting) and generating a next data block. The blockchain may include a blockchain underlying platform, a platform product service layer, and an application service layer.

4. A smart contract is a computer protocol designed to propagate, verify, or execute contacts in a digital manner. The smart contract permits trusted transactions to be performed without a third party, and these transactions are traceable and irreversible.

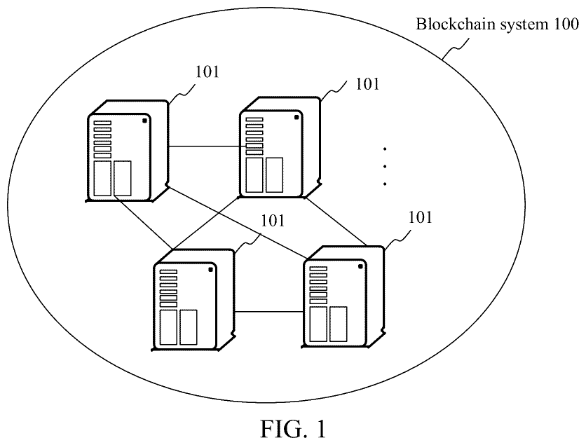

In the embodiments of this application, FIG. 1 is a schematic architectural diagram of a blockchain system according to an embodiment of this application. As shown in FIG. 1, the blockchain system 100 is a system for data sharing between blockchain nodes. The blockchain system 100 may include a plurality of blockchain nodes 101. The plurality of blockchain nodes 101 each may be a client in a data sharing system. Each blockchain node 101 may receive inputted information during normal operation, and maintain shared data in the data sharing system based on the received inputted information. To ensure information interoperability in the data sharing system, there may be an information connection between any two blockchain nodes in the data sharing system, and information transmission may be performed between the blockchain nodes through the information connection. For example, when any blockchain node in the data sharing system receives input information, other blockchain nodes in the data sharing system obtain the input information according to a consensus algorithm, and store the input information as shared data, so that data stored on all blockchain nodes in the data sharing system is consistent.

Any blockchain node mentioned in the embodiments of this application may be a computer device. The computer device in the embodiments of this application includes, but is not limited to, a terminal device or a server. In other words, the computer device may be a server or a terminal device, or may be a system including a server and a terminal device. Alternatively, the computer device may be a terminal device cluster, a server cluster, or the like, or may be a virtual device or the like. This is not limited herein. The terminal device mentioned above may be an electronic device, including but not limited to a mobile phone, a tablet computer, a desktop computer, a palmtop computer, an in-vehicle device, an augmented reality/virtual reality (AR/VR) device, a helmet-mounted display, a smart television, a wearable device, a smart speaker, a digital camera, a camera and another mobile Internet device (MID) with a network access capability, a terminal device in scenarios such as trains, ships, or flights, or the like. The server mentioned above may be an independent physical server, or may be a server cluster including a plurality of physical servers or a distributed system, or may be a cloud server that provides a cloud service, a cloud database, cloud computing, a cloud function, cloud storage, a network service, cloud communication, a middleware service, a domain name service, a security service, vehicle infrastructure cooperation, a content delivery network (CDN), and a basic cloud computing service such as big data and an artificial intelligence platform.

Some data involved in the embodiments of this application may be stored in the computer device, or may be stored based on a cloud storage technology or a blockchain network. This is not limited herein.

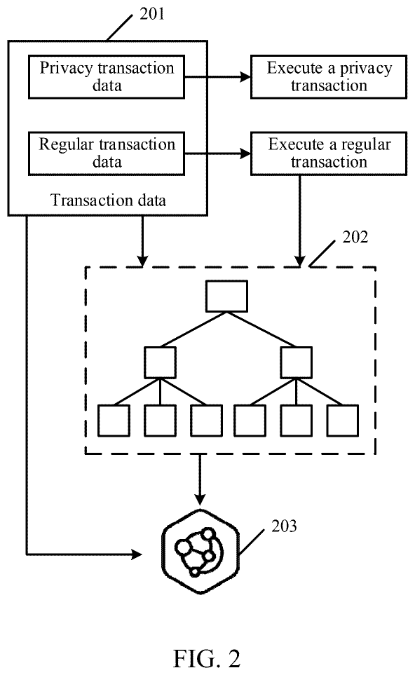

Specifically, FIG. 2 is a schematic diagram showing a transaction management scenario according to an embodiment of this application. For description purpose, the blockchain node mentioned below can be any blockchain node shown in FIG. 2. The blockchain node may be denoted as a target node, and the target node may obtain transaction data 201. The transaction data 201 may include privacy transaction data, or may include privacy transaction data and regular transaction data, or may include regular transaction data, or the like. Further, assuming that the transaction data 201 includes privacy transaction data and regular transaction data, a privacy transaction corresponding to the privacy transaction data may be executed, and a regular transaction corresponding to the regular transaction data may be executed. A Merkle management tree 202 may be generated based on the transaction data 201 and the regular transaction corresponding to the regular transaction data. A transaction block is generated based on the Merkle management tree 202 and the transaction data 201, and on-chain processing is performed on the transaction block, that is, the transaction block is added into a blockchain network 203. In this manner, the privacy transaction and the regular transaction can be executed in a unified system. However, for transactions that can be executed only by a single blockchain node or several blockchain nodes, in a case that the execution procedure same as that of the regular transaction is used, only the data generation manner involved in the on-chain storage process is changed. In other words, in the data (namely, the transaction block) that needs to be obtained by a plurality of blockchain nodes, the data generated in the execution process of the privacy transaction is not considered, so that even when the privacy transaction can be executed by only a single blockchain node or several blockchain nodes, each blockchain node can obtain the same input and output for the transaction data. Therefore, this manner enables consensus, maintaining consistency in a data processing manner or a data processing procedure for the regular transaction data and the privacy transaction data, and avoiding inconsistency in data obtained through transactions executed by the blockchain nodes due to characteristics of the privacy transaction. In this way, an off-chain service can also use an on-chain information transmission channel, simplifying the system architecture, reducing the development difficulty and workload, minimizing network vulnerabilities, lowering the difficulty of operation and maintenance, and improving the convenience and efficiency of transaction management.

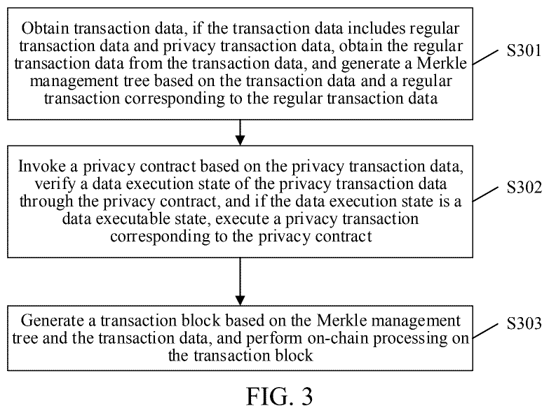

Further, FIG. 3 is a flowchart of a blockchain-based transaction management method according to an embodiment of this application. In FIG. 3, for description purpose, the blockchain node used as an execution subject can be any blockchain node. Such blockchain node is denoted as a target node. A blockchain-based transaction management process includes the following operations.

Operation S301: Obtain transaction data, if the transaction data includes regular transaction data and privacy transaction data, obtain the regular transaction data from the transaction data, and generate a Merkle management tree based on the transaction data and a regular transaction corresponding to the regular transaction data.

In this embodiment of this application, the target node may obtain the transaction data. The transaction data may be transaction data generated in the target node, or may be transaction data transmitted by another blockchain node, or may include transaction data respectively generated by the target node and another blockchain node, or the like. The target node may detect whether the privacy transaction data exists in the transaction data. If the privacy transaction data does not exist, a transaction corresponding to the transaction data is executed, the Merkle management tree is generated based on the transaction data and the transaction corresponding to the transaction data, a transaction block is generated based on the Merkle management tree and the transaction data, and on-chain processing is performed on the transaction block. If the privacy transaction data exists, the regular transaction data is obtained from the transaction data, the Merkle management tree is generated based on the transaction data and the regular transaction corresponding to the regular transaction data, and further, operation S302 and operation S303 are performed. The regular transaction data refers to transaction data other than the privacy transaction data in the transaction data.

Specifically, the target node may obtain the transaction data, a proxy contract is triggered based on the transaction data, and a service contract corresponding to the transaction data is invoked through the proxy contract. If the service contract is a regular contract, the transaction data is determined as the regular transaction data. If the service contract is a privacy contract, the transaction data is determined as the privacy transaction data. In some embodiments, when a service contract deployed in a blockchain system is deployed, the service contract may carry a contract identifier, and the target node may obtain the contract identifier carried in the service contract. If a contract identifier carried in the service contract corresponding to the transaction data is a regular contract identifier, or if the service contract corresponding to the transaction data does not carry a contact identifier, the service contract is determined as the regular contract. If a contract identifier carried in the service contract corresponding to the transaction data is a privacy contract identifier, the service contract is determined as the privacy contract. Alternatively, a contract invocation manner of the service contract may be obtained. If the contract invocation manner is a decryption invocation manner, the service contract is determined as the privacy contract. If the contract invocation manner is a direct invocation manner, the service contract is determined as the regular contract. Alternatively, if invocation of the service contract fails, or if the service contract is deployed in a decryption manner, the service contract is determined as the privacy contract. If the service contract is directly deployed, the service contract is determined as the regular contract. In some embodiments, there may be one or more (namely, at least two) pieces of transaction data. Through the foregoing method, a data attribute of each piece of transaction data may be determined, that is, the regular transaction data and the privacy transaction data included by the transaction data may be determined.

The privacy contract is a smart contract configured for verifying or executing a privacy transaction, and may also be referred to as a privacy smart contract. The regular contract is a smart contract configured for verifying or executing the regular transaction, and may also be referred to as a regular smart contract. A contract (for example, the service contract) may be classified into the privacy contract or the regular contract based on an identifier configured when the contract is created or deployed, an invocation manner of the contract, and a deployment manner of the contract. For example, the privacy contract includes, but is not limited to: a contract carrying a privacy identifier, a contract with an invocation manner being a decryption invocation manner, a contract deployed in a decryption manner, or the like. The regular contract includes, but is not limited to: a contract carrying a regular identifier or not carrying an identifier, a contract with an invocation manner being a direct invocation manner, a contract directly deployed, or the like.

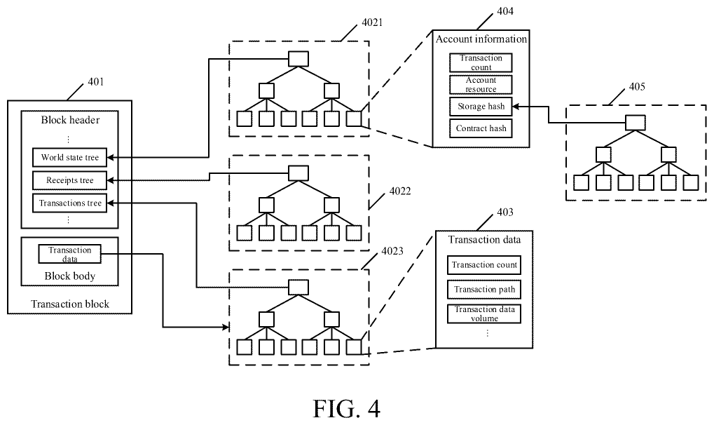

Further, if the transaction data includes the regular transaction data and the privacy transaction data, the regular transaction data is obtained from the transaction data, and the Merkle management tree is generated based on the transaction data and the regular transaction corresponding to the regular transaction data. Specifically, the Merkle management tree includes a transactions tree, a receipts tree, and a world state tree. The Merkle management tree is a data structure, and is configured for storing various types of data in the blockchain system. The transactions tree represents inputs, and is configured for recording transaction inputs. The receipts tree and the world state tree represent outputs, the receipts tree is configured for recording transaction outputs, and the world state tree is configured for recording state information of all accounts and the like. When the inputs and outputs of all blockchain nodes are consistent, it may be considered that the blockchain nodes remain consistent. Specifically, the target node may generate a transactions tree based on the transaction data. The transactions tree includes all transaction data. The transaction data is configured for representing transaction records, including but not limited to, the transaction sender, receiver, transaction data amount, and the like. Since a transaction count included in each block in the blockchain system is limited, a height of the transactions tree is usually low, allowing for quick verification and update. In some embodiments, reference may be made to FIG. 4. FIG. 4 is a schematic diagram showing a tree-shaped construction scenario according to an embodiment of this application. As shown in FIG. 4, the Merkle management tree is configured for generating a transaction block 401. Specifically, the target node may obtain transaction data 403. The transaction data 403 may include, but is not limited to a transaction count, a transaction path (namely, a direction of resource transfer), a transaction data volume (namely, a data volume of a resource to be transferred in a transaction corresponding to the transaction data 403), and the like. A transaction data hash is generated based on the transaction data 403. A transactions tree 4023 is formed by using the transaction data hash corresponding to the transaction data 403. For details, reference may be referred to the foregoing descriptions of a generation process of the Merkle tree. There may be one or more pieces of transaction data 403, that is, a transaction data hash corresponding to each piece of transaction data 403 may be equivalent to one leaf node. In some embodiments, the transaction data 403 may be divided into a plurality of transaction data blocks, a block hash corresponding to each transaction data block is obtained, and the leaf node is formed by using the block hash corresponding to each transaction data block, to generate the transactions tree 4023. Certainly, if the transactions tree 4023 is constructed in a block division manner, data block division manners used by different blockchain nodes need to be the same, to ensure data consistency.

The target node may obtain privacy on-chain data corresponding to the privacy transaction data. Specifically, a default parameter may be determined as the privacy on-chain data corresponding to the privacy transaction data. The default parameter may be a preset fixed parameter configured for referring to the privacy transaction data, for example, may be a placeholder or another meaningless string (for example, a string formed by 0s). This is not limited herein. In some embodiments, the privacy on-chain data may be data configured for constructing the receipts tree and the world state tree. Alternatively, the privacy on-chain data may include first privacy on-chain data configured for constructing the receipts tree, second privacy on-chain data configured for constructing the world state tree, and the like. Further, regular transaction information generated by executing the regular transaction corresponding to the regular transaction data may be obtained, and regular account information corresponding to the regular transaction data may be obtained. The regular transaction information is information generated by the regular transaction corresponding to the regular transaction data. The regular account information is account information of the regular transaction data. The receipts tree, for example, a receipts tree 4022 shown in FIG. 4, is constructed based on the privacy on-chain data and the regular transaction information. The world state tree, for example, a world state tree 4021 shown in FIG. 4, is constructed based on the privacy on-chain data and the regular account information. In other words, when the privacy transaction corresponding to the privacy transaction data can be executed only by a single blockchain node or several blockchain nodes, data inconsistency of the blockchain nodes is caused. Therefore, the privacy on-chain data is used to refer to the transaction information corresponding to the privacy transaction data, so that regardless of whether the privacy transaction can be executed, the same data can participate in data generation, consensus, and the like, thereby ensuring data consistency. This eliminates the need for a dedicated off-chain transaction system for the privacy transaction, thereby improving the convenience of transaction management.

When the regular transaction information generated by executing the regular transaction corresponding to the regular transaction data is obtained, and the regular account information corresponding to the regular transaction data is obtained, the regular smart contract corresponding to the regular transaction data may be invoked through the regular transaction data, and the regular transaction corresponding to the regular transaction data may be executed through the regular smart contract, to obtain a regular transaction execution result. The regular transaction execution result is configured for representing a result of executing the regular transaction, including a successful transaction execution result, a failed transaction execution result, and the like. Regular log information generated in the execution process of the regular transaction is obtained, and the regular transaction execution result and the regular log information are used to form the regular transaction information generated by the regular transaction. The regular transaction information may assist in verifying the legitimacy of the corresponding transaction and in querying and debugging the corresponding transaction. A transaction count of a regular account corresponding to the regular smart contract is updated based on the regular transaction, a regular transaction hash (namely, a contract hash) is generated based on the transaction count of the regular account, and the regular transaction hash and account data of the regular account are used to form the regular account information corresponding to the regular transaction data. In some embodiments, the account data of the regular account may include, but is not limited to an account resource (that is, an account balance, which represents a data volume of a resource owned by the regular account), contract code, contract data, and the like. The regular account information may assist in verifying the legitimacy and consistency of the transaction, and may support implementation of the smart contract.

As shown in FIG. 4, the target node may obtain a root node hash in an account storage tree 405, and use the root node hash as a storage hash. The account data, for example, the account resource and the transaction count, of the regular account corresponding to the regular transaction data is obtained. The storage hash, the regular transaction hash, the account data, and the like are used to form regular account information 404 of the regular account. The world state tree 4021 is constructed based on the privacy on-chain data and the regular account information; or when the privacy on-chain data includes the first privacy on-chain data and the second privacy on-chain data, the world state tree 4021 is constructed based on the second privacy on-chain data and the regular account information; or the like.

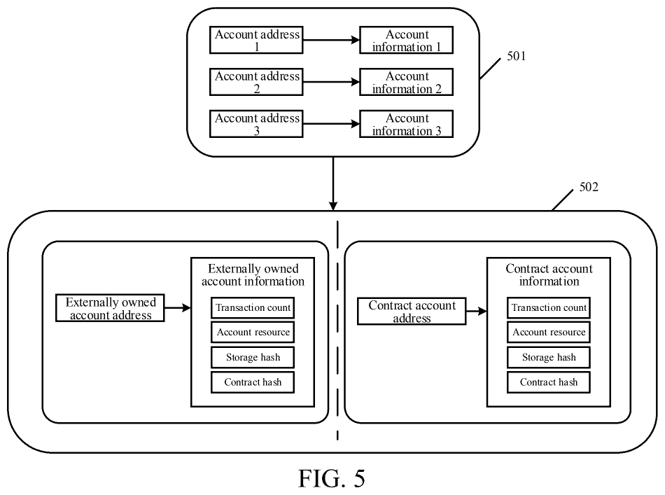

The world state tree may maintain an association relationship between an account address and account information. For example, reference may be made to FIG. 5. FIG. 5 is a schematic diagram showing world state tree data according to an embodiment of this application. As shown in FIG. 5, a world state tree 501 may maintain the association relationship between the account address and the account information, for example, an account address 1 corresponds to account information 1, or an account address 2 corresponds to account information 2. An account, for example, an account 502, is used as an example. Generally, there are two types of accounts: an externally owned account (EOA) and a contract account. The EOA is an ordinary account that can transfer a resource out (for example, make a transfer) and transfer a resource in (for example, receive a transfer), while the contract account is a special account that contains contract code, contract data, and the like. All contract invocations are initially triggered by the externally owned account. When the externally owned account invokes a smart contract, the smart contract may be executed, and then the contract account may also invoke another smart contract, to form a complex contract invocation chain. This chain-based invocation design manner enables the blockchain system to support various complex smart contracts, thereby achieving more functions. The contract account may include, but is not limited to a transaction count (nonce), which is configured for representing a number of transactions initiated by the contract account. The contract account may be configured for avoiding a replay attack and ensure that each transaction is unique. When the contract account initiates a new transaction, the transaction count is updated, for example, is added by one, and a new transaction count is written into the transaction. This ensures that even if an attacker obtains an old transaction, the attacker cannot replay the transaction, thereby improving the data security. The contract account may further include the account resource (a balance), the storage hash (a storage root), the contract hash (a code hash), and the like.

Operation S302: Invoke a privacy contract based on the privacy transaction data, verify a data execution state of the privacy transaction data through the privacy contract, and if the data execution state is a data executable state, execute a privacy transaction corresponding to the privacy contract.

In this embodiment of this application, the target node may invoke a proxy contract based on the privacy transaction data, and transfer a transaction encryption parameter and a transaction parameter signature to the proxy contract. The transaction parameter signature is obtained by signing the transaction encryption parameter with a private key of a first participating object. The transaction encryption parameter refers to an encryption parameter used during a transaction. The transaction encryption parameter and the transaction parameter signature may be data carried in the privacy transaction data. The transaction encryption parameter may be decrypted by using a private key of a target node through the proxy contract, to obtain a transaction parameter. The target node refers to a node obtaining transaction data. The privacy contract is invoked through the proxy contract, the transaction parameter is transferred to the privacy contract, and the transaction parameter signature is verified through the privacy contract. If the verification on the transaction parameter signature succeeds, the data execution state of the privacy transaction data is determined as the data executable state; or if the verification on the transaction parameter signature fails, the data execution state of the privacy transaction data is determined as a data non-executable state.

Alternatively, the proxy contract is invoked through the privacy transaction data, and a privacy contract corresponding to the privacy transaction data is determined in the proxy contract; and the contract invocation function in the proxy contract is invoked, the privacy contract is invoked by using the contract invocation function, and the data execution state of the privacy transaction data is verified through the privacy contract. For the manner of verifying the data execution state of the privacy transaction data through the privacy contract, reference may be made to the previous section.

Further, if the data execution state is the data executable state, a privacy transaction corresponding to the privacy contract is executed, and operation S303 is further performed. If the data execution state is the data non-executable state, operation S303 is performed.

Operation S303: Generate a transaction block based on the Merkle management tree and the transaction data, and perform on-chain processing on the transaction block.

In this embodiment of this application, the transaction block is generated based on the Merkle management tree and the transaction data, and the transaction block is broadcast to a first consensus node for consensus; and on-chain processing is performed on the transaction block if the consensus node has reached consensus on the transaction block. When broadcasting the transaction block to the first consensus node for consensus, the target node may also receive a consensus-pending transaction block transmitted by the first consensus node, and compare the transaction block with the consensus-pending transaction block, to obtain a first consensus result for the consensus-pending transaction block. In some embodiments, if the transaction block is the same as the consensus-pending transaction block, a data consensus success is determined as the first consensus result. If the transaction block is different from the consensus-pending transaction block, a data consensus failure is determined as the first consensus result. The first consensus result is broadcast to the first consensus node, to cause the first consensus node to perform on-chain processing on the consensus-pending transaction block when detecting that consensus on the consensus-pending transaction block has been reached.

In some embodiments, tree root information of the Merkle management tree may be obtained, a block header is constructed based on the tree root information, a block body is constructed based on the transaction data, and the block header and the block body are used to form the transaction block. The tree root information may include transaction root information of a root node of the transactions tree, receipt root information of a root node of the receipts tree, state root information of a root node of the world state tree, and the like. In some embodiments, alternatively, the block header may be constructed directly based on the Merkle management tree, the block body is constructed based on the transaction data, and the block header and the block body are used to form the transaction block.

In some embodiments, an execution sequence of the foregoing operations may not be limited. For example, after the transaction data is obtained, the transaction corresponding to the transaction data may be first processed, including operation S302. Then the Merkle management tree is generated (that is, operation S301), the transaction block is generated (that is, operation S303), and the like. Alternatively, operation S301 and operation S303 may be performed first. Then operation S302 is performed. This is not limited herein.

In the embodiments of this application, the transaction data may be obtained, if the transaction data includes the regular transaction data and the privacy transaction data, the regular transaction data is obtained from the transaction data, and the Merkle management tree is generated based on the transaction data and the regular transaction corresponding to the regular transaction data. The regular transaction data refers to the transaction data other than the privacy transaction data in the transaction data. The privacy contract is invoked based on the privacy transaction data, the data execution state of the privacy transaction data is verified through the privacy contract, and if the data execution state is the data executable state, the privacy transaction corresponding to the privacy contract is executed. The transaction block is generated based on the Merkle management tree and the transaction data, and on-chain processing is performed on the transaction block. Through the foregoing process, two types of transactions can be integrated into one system for implementation, meaning that an original system architecture of the blockchain node is maintained. By directly using the on-chain system, both the privacy transaction and the regular transaction can be managed, allowing an off-chain service (namely, a privacy transaction service) to also use an on-chain information transmission channel. This enables seamless integration between on-chain and off-chain transactions, simplifies the system architecture, and allows all business functions to be implemented with a single system, simplifying the technical solutions, and reducing development costs and maintenance difficulty. In addition, when data transmission is needed during transaction management, the execution process of the privacy transaction can be ignored, which means that the transaction data and relevant data in the execution process of the regular transaction corresponding to the regular transaction data are directly transmitted. Therefore, even a blockchain node incapable of executing the privacy transaction can obtain the same execution-related data for the privacy transaction, thereby ensuring data consistency across a plurality of transaction types in the same system. This avoids the impact of the privacy transaction on an on-chain data processing process, thereby improving the convenience and efficiency of transaction management.

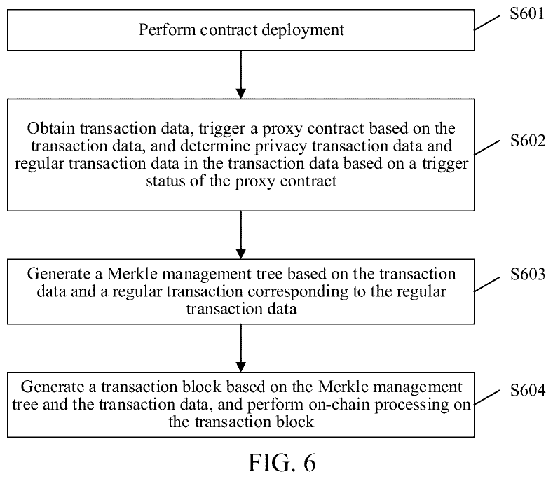

Further, reference may be made to FIG. 6. FIG. 6 is a flowchart showing exemplary transaction management according to an embodiment of this application. As shown in FIG. 6, a process may include the following operations.

Operation S601: Perform contract deployment.

In this embodiment of this application, a contract deployment function, a contract invocation function, and a privacy account management function may be constructed, the contract deployment function, the contract invocation function, and the privacy account management function are integrated into contract code to generate a proxy contract, and the proxy contract is deployed. The proxy contract is configured for deploying and invoking a privacy contract and managing a privacy account. The proxy contract uses an encryption technology, and is responsible for decrypting the privacy contract, a contract invocation request, and the like. In addition, the proxy contract may encrypt a returned result obtained through contract invocation, thereby protecting privacy and data security. The contract deployment function is configured for deploying encrypted privacy contract code on a blockchain network, to create a privacy contract. When the privacy contract is deployed, the proxy contract may use a key of a node to decrypt the privacy contract, and decrypt the encrypted privacy contract code, to protect privacy and security of the privacy contract. The contract invocation function is configured for invoking the deployed privacy contract, and transmitting an encrypted transaction parameter. When the privacy contract is invoked, the proxy contract may use a key of a node to decrypt the encrypted transaction parameter, to protect privacy and security of the parameter. After the contract invocation is completed, the proxy contract may use a public key of an invoking party to encrypt the returned result, and provide feedback to the invoking party. The privacy account management function is configured for adding an account address into the privacy contract, to create a privacy account. Only the privacy account can deploy the privacy contract, preventing an ordinary user from abusing the privacy account management function to deploy a large number of privacy contracts. The privacy account may be configured for protecting account privacy and security, to prevent the account from being attacked and stole. Through deployment of the proxy contract, the privacy and data security can be protected. In addition, a convenient interface is provided, so that a developer can more conveniently deploy and use the privacy contract. For functions included in the proxy contract, reference may be made to Table 1.

TABLE 1
Proxy contract

+Contract deployment function (encrypted privacy contract)
+Contract invocation function (contract address, encrypted transaction
parameter)
+Privacy account management function (account address)
−Decrypt the privacy contract (encrypted privacy contract)
−Encrypt a returned result ( )

Further, the privacy contract may be deployed through the contract deployment function in the proxy contract. Specifically, a data encryption key (DEK) may be generated. The privacy contract (referred to as C) is encrypted by using the data encryption key, to obtain an encrypted privacy contract (referred to as D). The DEK may be considered as a symmetric encryption key, which is a symmetric key configured to encrypt and decrypt actual data. During communication, if the DEK is exposed or leaked, communicating parties only need to change the DEK without changing a key encryption key (KEK). This can reduce a number of times the key is renegotiated between the communicating parties and improve communication security. Further, the data encryption key is encrypted by using a public key of a first node, to generate key protection data. Certainly, assuming that the privacy contract is deployed by a target node, herein in other words, the data encryption key is encrypted by using a public key of the target node, to generate the key protection data. Further, a contract signature for the encrypted privacy contract and the key protection data is generated by using a private key of a second participating object. The encrypted privacy contract, the key protection data, and the contract signature are transmitted to the proxy contract, and the privacy contract is deployed through the proxy contract, the encrypted privacy contract, the key protection data, and the contract signature.

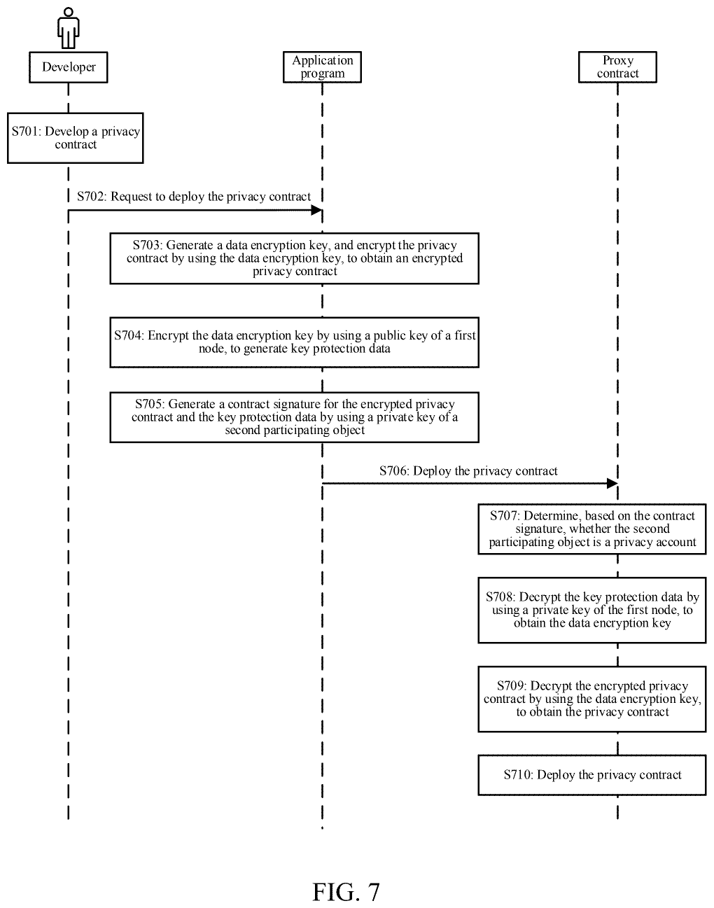

When the privacy contract is deployed through the proxy contract, the encrypted privacy contract, the key protection data, and the contract signature, the contract signature may be verified, and if the second participating object is a privacy account, the key protection data is decrypted by using a private key of the target node, to obtain the data encryption key. That is to say, only the privacy account can perform deployment of the privacy contract, improving accuracy of contract management and contract security. The encrypted privacy contract is decrypted by using the data encryption key, to obtain the privacy contract, and the privacy contract is deployed. In some embodiments, when the privacy contract is deployed, a first contract address of the privacy contract may be obtained, and the first contract address is associated with the proxy contract. Alternatively, the encrypted privacy contract, the key protection data, and the contract signature may be directly associated with the proxy contract. In some embodiments, for an exemplary deployment process of the privacy contract, reference may be made to FIG. 7, which will be described later.

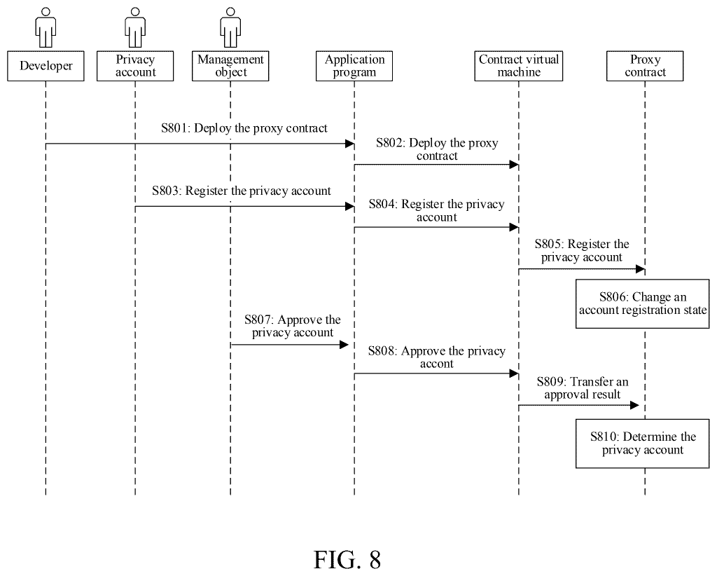

The privacy account may be an account registered in advance. Specifically, in response to a privacy account registration request, through the proxy contract, a registration signature carried in the privacy account registration request may be verified. The registration signature refers to a signature generated with the private key of the second participating object, and the second participating object refers to an object that registers the privacy account. If the verification on the registration signature succeeds, an account registration state for the privacy account registration request is updated to a to-be-confirmed state (also referred to as a “confirmation pending state”), and the privacy account registration request is forwarded to a management device, to cause the management device to feed back an account registration confirmation message after verification on the privacy account registration request succeeds. Through the proxy contract, a registration management signature carried in the account registration confirmation message is verified, and if the verification on the registration management signature succeeds, the account registration state is updated to a confirmed state. The second participating object is determined as the privacy account based on the account registration state. Specifically, when the account registration state is the confirmed state, an account address of the second participating object may be obtained. The account address of the second participating object is added into the proxy contract, and the second participating object indicated by the account address is determined as the privacy account. In an exemplary implementation, reference may be made to FIG. 8.

Operation S602: Obtain transaction data, trigger the proxy contract based on the transaction data, and determine privacy transaction data and regular transaction data in the transaction data based on a trigger status of the proxy contract.

In this embodiment of this application, the target node may obtain the transaction data, trigger the proxy contract based on the transaction data, and invoke a service contract corresponding to the transaction data through the proxy contract. If the service contract is a regular contract, the transaction data is determined as the regular transaction data. If the service contract is a privacy contract, the transaction data is determined as the privacy transaction data. When there is a number of pieces of transaction data, through the foregoing process, the privacy transaction data and the regular transaction data in the transaction data may be determined. For details, reference may be made to relevant descriptions of operation S301 in FIG. 3.

Operation S603: Generate a Merkle management tree based on the transaction data and a regular transaction corresponding to the regular transaction data.

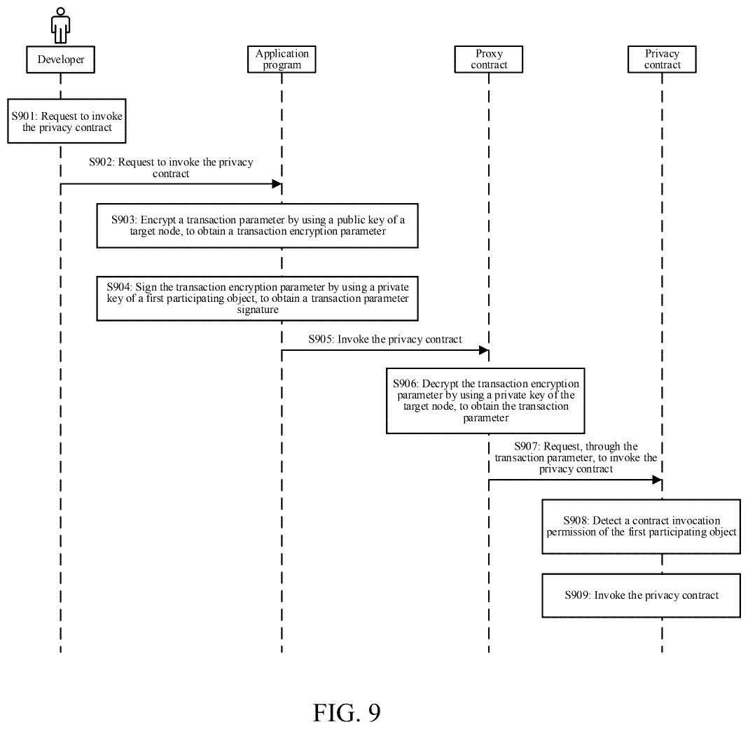

In this embodiment of this application, reference may be made to relevant descriptions of operation S301 in FIG. 3, and details are not described herein again. The regular transaction corresponding to the regular transaction data may be executed, to obtain regular transaction information, regular account information, and the like. The Merkle management tree is generated based on the transaction data and the regular transaction corresponding to the regular transaction data, and operation S604 is performed. In some embodiments, a privacy transaction corresponding to the privacy transaction data may be executed. For details, reference may be made to FIG. 9 below. Then, operation S604 is performed.

Operation S604: Generate a transaction block based on the Merkle management tree and the transaction data, and perform on-chain processing on the transaction block.

In this embodiment of this application, reference may be made to specific descriptions of operation S303 in FIG. 3, and details are not described herein again. Certainly, when the privacy transaction corresponding to the privacy transaction data is not executed in operation S603, the privacy transaction corresponding to the privacy transaction data may be executed after on-chain processing is performed on the transaction block.

In some embodiments, after the privacy transaction is executed, privacy transaction information generated by the privacy transaction may be obtained, a privacy block is generated based on the privacy transaction information, and the privacy block is added to a privacy blockchain. The privacy blockchain may be considered as a private chain, and is stored locally in the target node. Alternatively, privacy transaction information generated by the privacy transaction may be obtained, a privacy data identifier corresponding to the privacy transaction data in the Merkle management tree is obtained, and the privacy data identifier and the privacy transaction information are stored in association.

Further, FIG. 7 is a schematic flowchart showing contract deployment according to an embodiment of this application. In FIG. 7, it is assumed that an execution subject is a second node, and a process may include the following operations.

Operation S701: Develop a privacy contract.

In this embodiment of this application, a developer may develop the privacy contract.

Operation S702: Request to deploy the privacy contract.

In this embodiment of this application, the developer may request, through an application program, to deploy the privacy contract.

Operation S703: Generate a data encryption key, and encrypt the privacy contract by using the data encryption key, to obtain an encrypted privacy contract.

In this embodiment of this application, the second node may generate the data encryption key (DEK) through the application program, and encrypt the privacy contract (referred to as C) by using the DEK, to obtain the encrypted privacy contract (referred to as D). The second node may be a node associated with the developer, or may be any blockchain node in a blockchain network.

Operation S704: Encrypt the data encryption key by using a public key of a first node, to generate key protection data.

In this embodiment of this application, the second node may encrypt the DEK by using the public key of the first node, to generate the key protection data (referred to as K). The first node refers to a node for deploying the privacy contract, namely, a node with a permission to invoke the privacy contract. In some embodiments, the second node, the first node, and a target node may be the same node, or may be different from each other. Alternatively, two nodes among the first node, the second node, and the target node are the same. This is not limited herein.

Operation S705: Generate a contract signature for the encrypted privacy contract and the key protection data by using a private key of a second participating object.

In this embodiment, the second node may generate the contract signature (which may be referred to as S) for the encrypted privacy contract D and the key protection data K by using the private key of the second participating object, that is, (D, K) is signed by using the private key of the second participating object, to obtain S.

Operation S706: Deploy the privacy contract.

In this embodiment of this application, the second node may invoke a proxy contract through the application program, to deploy the privacy contract. Specifically, (D, K, S) is transferred to the proxy contract through the application program, and operations S707 to S710 are performed in the proxy contract, to deploy the privacy contract.

Operation S707: Determine, based on the contract signature, whether the second participating object is a privacy account.

In this embodiment of this application, the second node may detect, based on the contract signature S, whether the second participating object is the privacy account. If the second participating object is the privacy account, operation S708 is performed.

Operation S708: Decrypt the key protection data by using a private key of the first node, to obtain the data encryption key.

In this embodiment of this application, (D, K, S) may be directly deployed in the proxy contract, to deploy the privacy contract. In other words, regardless of whether the second node and the first node are the same node, deployment may be directly performed. Alternatively, when the second node and the first node are not the same node, the second node cannot decrypt the foregoing data. In other words, in this case, the second node directly deploys (D, K, S) in the proxy contract, to deploy the privacy contract. The first node may deploy the privacy contract obtained through decryption in the proxy contract. In other words, when the foregoing data cannot be decrypted, or a node without a permission to execute the privacy contract may directly deploy the encrypted privacy contract, a node with a permission to execute the privacy contract deploys the privacy contract obtained through decryption. Specifically, for example, the second node and the first node are the same node. A decryption and deployment process may be that the key protection data K is decrypted by using the private key of the first node, to obtain the data encryption key DEK. Further, operation S709 is performed.

Operation S709: Decrypt the encrypted privacy contract by using the data encryption key, to obtain the privacy contract.

In this embodiment of this application, the encrypted privacy contract D is decrypted by using the DEK, to obtain the privacy contract C.

Operation S710: Deploy the privacy contract.

In this embodiment of this application, the privacy contract is deployed in a blockchain system. Specifically, a contract address of the privacy contract may be associated with the proxy contract, so that the privacy contract may be invoked through a contract invocation function in the proxy contract.

In this embodiment of this application, the generated DEK is configured for encrypting the privacy contract. This can ensure security of the privacy contract in a transmission process. Then, security and authenticity of the DEK are ensured by using the key encryption key KEK of the node and using a private key signature of the privacy account. Further, based on the foregoing encryption process, reverse decryption is performed, ensuring confidentiality and integrality of the privacy contract. In this manner, the privacy contract can be deployed and executed on the premise of ensuring the confidentiality and integrality.

Further, FIG. 8 is a schematic flowchart showing account registration according to an embodiment of this application. In FIG. 8, a third node being an execution subject may be used as an example for description. The third node may be any blockchain node in a blockchain system, and a process may include the following operations.

Operation S801: Deploy a proxy contract.

In this embodiment of this application, a developer may request, through an application program, to deploy the proxy contract. In some embodiments, a management object of the proxy contract may be set.

Operation S802: Deploy the proxy contract.

In this embodiment of this application, the proxy contract may be deployed in a contract virtual machine through the application program.

Operation S803: Register a privacy account.

In this embodiment of this application, a second participating object (being the privacy account after the registration succeeds) transmits a privacy account registration request to the contract virtual machine through the application program.

Operation S804: Register the privacy account.

In this embodiment of this application, the third node forwards the privacy account registration request to the contract virtual machine through the application program.

Operation S805: Register the privacy account.

In this embodiment of this application, the proxy contract is invoked through the contract virtual machine, to register the privacy account.

Operation S806: Change an account registration state.

In this embodiment of this application, the third node may verify, through the proxy contract, a registration signature carried in the privacy account registration request. If the verification on the registration signature succeeds, an account registration state for the privacy account registration request is updated to a to-be-confirmed state. The privacy account registration request is forwarded to a management device. The management device is a device associated with a management object. Certainly, the management device may be the third node, or may be another device.

Operation S807: Approve the privacy account.

In this embodiment of this application, the management object may approve the privacy account.

Operation S808: Approve the privacy account.

In this embodiment of this application, the third node may transmit an approval result of the account to the contract virtual machine through the application program.

Operation S809: Transfer the approval result.

In this embodiment of this application, the third node may transfer the approval result of the account to the proxy contract through the contract virtual machine. If the approval result of the account is an account registration confirmation message, the account registration confirmation message may be transferred to the proxy contract.

Operation S810: Determine the privacy account.

In this embodiment of this application, the third node may verify, through the proxy contract, a registration management signature carried in the account registration confirmation message. If the verification on the registration management signature succeeds, the account registration state is updated to a confirmed state, and the second participating object is determined as the privacy account.

In this embodiment of this application, the privacy account is added, so that only the privacy account can deploy the privacy contract. In this way, privacy and security of the account can be protected, thereby avoiding a large amount of malicious deployment of the privacy contract and improving efficiency of contract management and security of contract deployment.

Further, FIG. 9 is a schematic flowchart showing contract invocation according to an embodiment of this application. In FIG. 9, a target node is used as an execution subject for description, and a process may include the following operations.

Operation S901: Request to invoke a privacy contract.

In this embodiment of this application, a developer may request to invoke the privacy contract.

Operation S902: Request to invoke the privacy contract.

In this embodiment of this application, the developer may request an application program to invoke the privacy contract.

Operation S903: Encrypt a transaction parameter by using a public key of the target node, to obtain a transaction encryption parameter.

In this embodiment of this application, the transaction parameter (args) may be encrypted through the application program by using the public key of the target node, to obtain the transaction encryption parameter.

Operation S904: Sign the transaction encryption parameter by using a private key of a first participating object, to obtain a transaction parameter signature.

In this embodiment of this application, the transaction encryption parameter may be signed by using the private key of the first participating object, to obtain the transaction parameter signature.

Operations S903 and S904 may be implemented in the target node, or may be implemented in a development device associated with the developer.

Operation S905: Invoke the privacy contract.

In this embodiment of this application, the target node may invoke a proxy contract through the application program, and invoke the privacy contract in the proxy contract. Specifically, the transaction encryption parameter and the transaction parameter signature are transferred to the proxy contract.

Operation S906: Decrypt the transaction encryption parameter by using a private key of the target node, to obtain the transaction parameter.

In this embodiment of this application, the target node may decrypt the transaction encryption parameter by using the private key of the target node, to obtain the transaction parameter args.

Operation S907: Request, through the transaction parameter, to invoke the privacy contract.

In this embodiment of this application, the target node may request, through the transaction parameter, to invoke the privacy contract in the proxy contract. Specifically, a contract invocation function in the proxy contract may be invoked, and the privacy contract is invoked based on a contract address of the privacy contract and the transaction parameter.

Operation S908: Detect a contract invocation permission of the first participating object.

In this embodiment of this application, the target node may detect the contract invocation permission of the first participating object. If it is detected that the contract invocation permission of the first participating object for the privacy contract exists, operation S909 is performed.

Operation S909: Invoke the privacy contract.

In this embodiment of this application, technologies such as an encryption algorithm, a signature algorithm, and a decryption algorithm are used, to ensure confidentiality, integrity, and authenticity of data. A function of the proxy contract is to ensure security and reliability of the privacy contract and prevent a malicious attack and data leakage. Specifically, the privacy contract includes operation logic of a service, and the privacy contract can be prevented from being invoked by an illegal invoking party in a processing manner such as encryption.

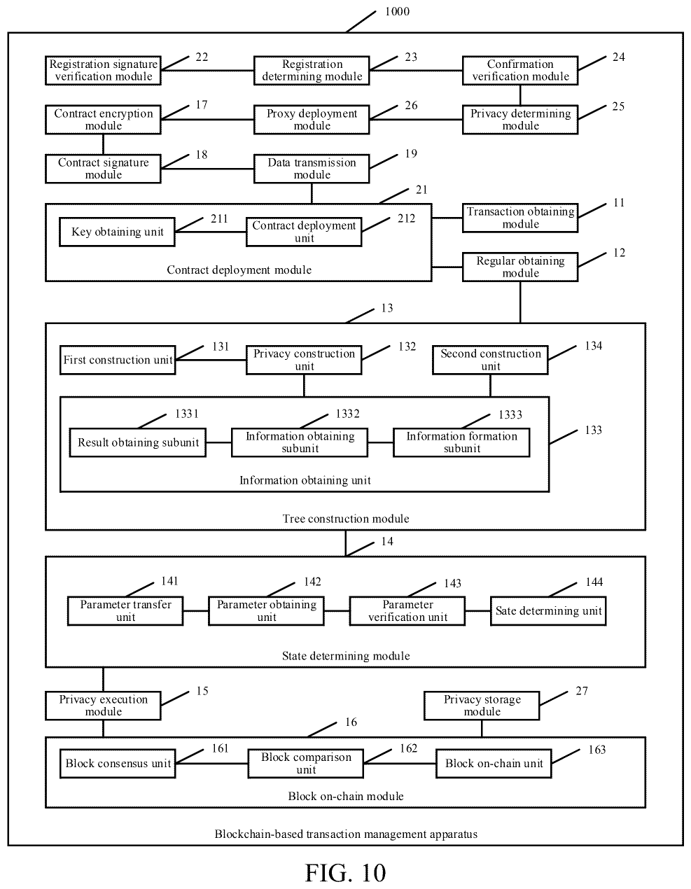

Further, FIG. 10 is a schematic diagram of a blockchain-based transaction management apparatus according to an embodiment of this application. The blockchain-based transaction management apparatus may be a computer program (including program code and the like) run in a computer device. For example, the blockchain-based transaction management apparatus may be application software. The apparatus may be configured to perform corresponding operations in the method provided in the embodiments of this application. The blockchain-based transaction management apparatus 1000 shown in FIG. 10 may be used for the method in the embodiment corresponding to FIG. 3. Specifically, the apparatus may include: a transaction obtaining module 11, a regular obtaining module 12, a tree construction module 13, a state determining module 14, a privacy execution module 15, and a block on-chain module 16.

The transaction obtaining module 11 is configured to obtain transaction data.

The regular obtaining module 12 is configured to obtain, if the transaction data includes regular transaction data and privacy transaction data, the regular transaction data from the transaction data.

The tree construction module 13 is configured to generate a Merkle management tree based on the transaction data and a regular transaction corresponding to the regular transaction data. The regular transaction data refers to transaction data other than the privacy transaction data in the transaction data.

The state determining module 14 is configured to invoke a privacy contract based on the privacy transaction data and verify a data execution state of the privacy transaction data through the privacy contract.

The privacy execution module 15 is configured to execute, if the data execution state is a data executable state, a privacy transaction corresponding to the privacy contract.

The block on-chain module 16 is configured to generate a transaction block based on the Merkle management tree and the transaction data, and perform on-chain processing on the transaction block.

The Merkle management tree includes a transactions tree, a receipts tree, and a world state tree. The tree construction module 13 includes:
a first construction unit 131, configured to generate the transactions tree based on the transaction data;
a privacy construction unit 132, configured to obtain privacy on-chain data corresponding to the privacy transaction data;
an information obtaining unit 133, configured to obtain regular transaction information generated by executing the regular transaction corresponding to the regular transaction data, and obtain regular account information corresponding to the regular transaction data; and
a second construction unit 134, configured to construct the receipts tree based on the privacy on-chain data and the regular transaction information, and construct the world state tree based on the privacy on-chain data and the regular account information.

The information obtaining unit 133 includes:
a result obtaining subunit 1331, configured to invoke a regular smart contract corresponding to the regular transaction data through the regular transaction data, and execute the regular transaction corresponding to the regular transaction data through the regular smart contract, to obtain a regular transaction execution result;
an information obtaining subunit 1332, configured to obtain regular log information generated in the execution process of the regular transaction, and use the regular transaction execution result and the regular log information to form the regular transaction information generated by the regular transaction; and
an information formation subunit 1333, configured to update a transaction count of a regular account corresponding to the regular smart contract based on the regular transaction, generate a regular transaction hash based on the transaction count of the regular account, and use the regular transaction hash and account data of the regular account to form the regular account information corresponding to the regular transaction data.

The state determining module 14 includes:
a parameter transfer unit 141, configured to invoke a proxy contract based on the privacy transaction data, and transfer a transaction encryption parameter and a transaction parameter signature to the proxy contract, the transaction parameter signature being obtained by signing the transaction encryption parameter with a private key of a first participating object;
a parameter obtaining unit 142, configured to decrypt the transaction encryption parameter by using a private key of a target node through the proxy contract, to obtain a transaction parameter, the target node referring to a node obtaining the transaction data;
a parameter verification unit 143, configured to invoke the privacy contract through the proxy contract, transfer the transaction parameter to the privacy contract, and verify the transaction parameter signature through the privacy contract; and
a state determining unit 144, configured to determine, if the verification on the transaction parameter signature succeeds, the data execution state of the privacy transaction data as the data executable state.

The state determining unit 144 is further configured to determine, if the verification on the transaction parameter signature fails, the data execution state of the privacy transaction data as a data non-executable state.

The block on-chain module 16 includes:
a block consensus unit 161, configured to generate the transaction block based on the Merkle management tree and the transaction data, and broadcast the transaction block to a first consensus node for consensus;
a block comparison unit 162, configured to receive a consensus-pending transaction block transmitted by the first consensus node, compare the transaction block with the consensus-pending transaction block, to obtain a first consensus result for the consensus-pending transaction block, and broadcast the first consensus result to the first consensus node, to cause the first consensus node to perform on-chain processing on the consensus-pending transaction block when detecting that consensus on the consensus-pending transaction block has been reached; and
a block on-chain unit 163, configured to perform on-chain processing on the transaction block if the consensus node has reached consensus on the transaction block.

The apparatus 1000 further includes:
a contract encryption module 17, configured to generate a data encryption key, and encrypt the privacy contract by using the data encryption key, to obtain an encrypted privacy contract;
a contract signature module 18, configured to encrypt the data encryption key by using a public key of the target node, to generate key protection data, and generate a contract signature for the encrypted privacy contract and the key protection data by using a private key of a second participating object;
a data transmission module 19, configured to transmit the encrypted privacy contract, the key protection data, and the contract signature to the proxy contract; and
a contract deployment module 21, configured to deploy the privacy contract through the proxy contract, the encrypted privacy contract, the key protection data, and the contract signature.

The contract deployment module 21 includes:
a key obtaining unit 211, configured to verify the contract signature, and if the second participating object is a privacy account, decrypt the key protection data by using the private key of the target node, to obtain the data encryption key; and
a contract deployment unit 212, configured to decrypt the encrypted privacy contract by using the data encryption key, to obtain the privacy contract, and deploy the privacy contract.

The apparatus 1000 further includes:
a registration signature verification module 22, configured to verify, in response to a privacy account registration request, through the proxy contract, a registration signature carried in the privacy account registration request, the registration signature referring to a signature generated with the private key of the second participating object;
a registration confirmation module 23, configured to: if the verification on the registration signature succeeds, update an account registration state for the privacy account registration request to a to-be-confirmed state, and forward the privacy account registration request to a management device, to cause the management device to feed back an account registration confirmation message after verification on the privacy account registration request succeeds;
a confirmation verification module 24, configured to verify, through the proxy contract, a registration management signature carried in the account registration confirmation message, and if the verification on the registration management signature succeeds, update the account registration state to a confirmed state; and
a privacy determining module 25, configured to determine the second participating object as the privacy account based on the account registration state.

The apparatus 1000 further includes:
a proxy deployment module 26, configured to construct a contract deployment function, a contract invocation function, and a privacy account management function, integrate the contract deployment function, the contract invocation function, and the privacy account management function into contract code to generate the proxy contract, and deploy the proxy contract.

The state determining module 14 is specifically configured to:
invoke the proxy contract through the privacy transaction data, and determine a privacy contract corresponding to the privacy transaction data in the proxy contract; and
invoke the contract invocation function in the proxy contract, invoke the privacy contract by using the contract invocation function, and verify the data execution state of the privacy transaction data through the privacy contract.

The apparatus 1000 further includes:
a privacy storage module 27, configured to obtain privacy transaction information generated by the privacy transaction, generate a privacy block based on the privacy transaction information, and add the privacy block to a privacy blockchain. Alternatively, the privacy storage module 27 is configured to obtain privacy transaction information generated by the privacy transaction, obtain a privacy data identifier corresponding to the privacy transaction data in the Merkle management tree, and store the privacy data identifier and the privacy transaction information in association.

This embodiment of this application provides the blockchain-based transaction management apparatus. The apparatus may obtain the transaction data, if the transaction data includes the regular transaction data and the privacy transaction data, obtain the regular transaction data from the transaction data, and generate the Merkle management tree based on the transaction data and the regular transaction corresponding to the regular transaction data. The regular transaction data refers to the transaction data other than the privacy transaction data in the transaction data. The privacy contract is invoked based on the privacy transaction data, the data execution state of the privacy transaction data is verified through the privacy contract, and if the data execution state is the data executable state, the privacy transaction corresponding to the privacy contract is executed. The transaction block is generated based on the Merkle management tree and the transaction data, and on-chain processing is performed on the transaction block. Through the foregoing process, two types of transactions can be integrated into one system for implementation, meaning that an original system architecture of the blockchain node is maintained. By directly using the on-chain system, both the privacy transaction and the regular transaction can be managed, allowing an off-chain service (namely, a privacy transaction service) to also use an on-chain information transmission channel. This enables seamless integration between on-chain and off-chain transactions, simplifies the system architecture, and allows all business functions to be implemented with a single system, simplifying the technical solutions, and reducing development costs and maintenance difficulty. In addition, when data transmission is needed during transaction management, the execution process of the privacy transaction can be ignored, which means that the transaction data and relevant data in the execution process of the regular transaction corresponding to the regular transaction data are directly transmitted. Therefore, even a blockchain node incapable of executing the privacy transaction can obtain the same execution-related data for the privacy transaction, thereby ensuring data consistency across a plurality of transaction types in the same system. This avoids the impact of the privacy transaction on an on-chain data processing process, thereby improving the convenience and efficiency of transaction management.

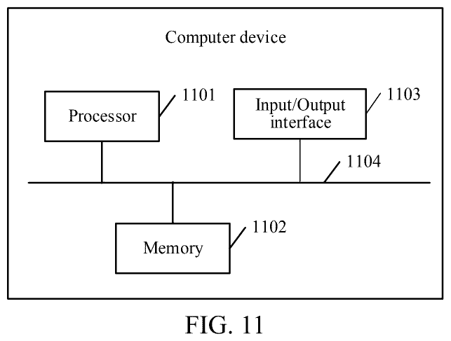

FIG. 11 is a schematic structural diagram of a computer device according to an embodiment of this application. As shown in FIG. 11, the computer device in this embodiment of this application may include one or more processors 1101, a memory 1102, and an input/output interface 1103. The processor 1101, the memory 1102, and the input/output interface 1103 are connected through a bus 1104. The memory 1102 is configured to store a computer program, and the computer program includes program instructions. The input/output interface 1103 is configured to perform data interaction between different blockchain nodes, or perform data interaction between different smart contracts. The processor 1101 is configured to execute program instructions stored in the memory 1102.

The processor 1101 may perform the following operations:
obtaining transaction data, if the transaction data includes regular transaction data and privacy transaction data, obtaining the regular transaction data from the transaction data, and generating a Merkle management tree based on the transaction data and a regular transaction corresponding to the regular transaction data, the regular transaction data referring to transaction data other than the privacy transaction data in the transaction data;
invoking a privacy contract based on the privacy transaction data, verifying a data execution state of the privacy transaction data through the privacy contract, and if the data execution state is a data executable state, executing a privacy transaction corresponding to the privacy contract; and
generating a transaction block based on the Merkle management tree and the transaction data, and performing on-chain processing on the transaction block.

In some feasible implementations, the processor 1101 may be a central processing unit (CPU). The processor may alternatively be another general-purpose processor, a digital signal processor (DSP), an application specific integrated circuit (ASIC), a field-programmable gate array (FPGA) or another programmable logic device, a discrete gate or a transistor logic device, a discrete hardware component, or the like. The general-purpose processor may be a microprocessor, or the processor may be any conventional processor or the like.

The memory 1102 may include a read-only memory and a random access memory, and provides the processor 1101 and the input/output interface 1103 with instructions and data. Apart of the memory 1102 may further include a non-volatile random access memory. For example, the memory 1102 may further store information about a device type.

In specific implementation, the computer device may perform the implementations provided in the operations in FIG. 3 through built-in functional modules of the computer device. For details, reference may be made to the implementations provided in the operations in FIG. 3, and details are not described herein again.

An embodiment of this application provides a computer device, including: a processor, an input/output interface, and a memory. The computer device obtains a computer program in the memory through the processor, and performs the operations of the method shown in FIG. 3, to perform a blockchain-based transaction management operation. In this embodiment of this application, the transaction data is obtained, if the transaction data includes the regular transaction data and the privacy transaction data, the regular transaction data is obtained from the transaction data, and the Merkle management tree is generated based on the transaction data and the regular transaction corresponding to the regular transaction data. The regular transaction data refers to the transaction data other than the privacy transaction data in the transaction data. The privacy contract is invoked based on the privacy transaction data, the data execution state of the privacy transaction data is verified through the privacy contract, and if the data execution state is the data executable state, the privacy transaction corresponding to the privacy contract is executed. The transaction block is generated based on the Merkle management tree and the transaction data, and on-chain processing is performed on the transaction block. Through the foregoing process, two types of transactions can be integrated into one system for implementation, meaning that an original system architecture of the blockchain node is maintained. By directly using the on-chain system, both the privacy transaction and the regular transaction can be managed, allowing an off-chain service (namely, a privacy transaction service) to also use an on-chain information transmission channel. This enables seamless integration between on-chain and off-chain transactions, simplifies the system architecture, and allows all business functions to be implemented with a single system, simplifying the technical solutions, and reducing development costs and maintenance difficulty. In addition, when data transmission is needed during transaction management, the execution process of the privacy transaction can be ignored, which means that the transaction data and relevant data in the execution process of the regular transaction corresponding to the regular transaction data are directly transmitted. Therefore, even a blockchain node incapable of executing the privacy transaction can obtain the same execution-related data for the privacy transaction, thereby ensuring data consistency across a plurality of transaction types in the same system. This avoids the impact of the privacy transaction on an on-chain data processing process, thereby improving the convenience and efficiency of transaction management.

An embodiment of this application further provides a computer-readable storage medium. The computer-readable storage medium has a computer program stored therein, the computer program being suitable for being loaded and executed by a processor to implement the blockchain-based transaction management method provided in the operations in FIG. 3. For details, reference may be made to the implementations provided in the operations in FIG. 3, and details are not described herein again. In addition, the description of beneficial effects of the same method is not described herein again. For technical details that are not disclosed in the embodiments of the computer-readable storage medium of this application, refer to the method embodiments of this application. In an example, the computer program may be deployed to be executed on a computer device, or deployed to be executed on a plurality of computer devices at the same location, or deployed to be executed on a plurality of computer devices that are distributed in a plurality of locations and interconnected by using a communication network.

The computer-readable storage medium may be the blockchain-based transaction management apparatus provided in any foregoing embodiment, or an internal storage unit of the computer device, for example, a hard disk or an internal memory of the computer device. The computer-readable storage medium may alternatively be an external storage device of the computer device, for example, a removable hard disk, a smart media card (SMC), a secure digital (SD) card, or a flash card equipped on the computer device. Further, alternatively, the computer-readable storage medium may include both an internal storage unit and an external storage device of the computer device. The computer-readable storage medium is configured to store the computer program and another program and data that are needed by the computer device. The computer-readable storage medium may be further configured to temporarily store data that has been output or data to be output.

An embodiment of this application further provides a computer program product or a computer program, the computer program product or the computer program including computer instructions, the computer instructions being stored in a computer-readable storage medium. A processor of a computer device reads the computer instructions from the computer-readable storage medium, and executes the computer instructions, to cause the computer device to perform the method provided in the exemplary manners in FIG. 3. In this way, two types of transactions can be integrated into one system for implementation, meaning that an original system architecture of the blockchain node is maintained. By directly using the on-chain system, both the privacy transaction and the regular transaction can be managed, allowing an off-chain service (namely, a privacy transaction service) to also use an on-chain information transmission channel. This enables seamless integration between on-chain and off-chain transactions, simplifies the system architecture, and allows all business functions to be implemented with a single system, simplifying the technical solutions, and reducing development costs and maintenance difficulty. In addition, when data transmission is needed during transaction management, the execution process of the privacy transaction can be ignored, which means that the transaction data and relevant data in the execution process of the regular transaction corresponding to the regular transaction data are directly transmitted. Therefore, even a blockchain node incapable of executing the privacy transaction can obtain the same execution-related data for the privacy transaction, thereby ensuring data consistency across a plurality of transaction types in the same system. This avoids the impact of the privacy transaction on an on-chain data processing process, thereby improving the convenience and efficiency of transaction management.

In the specification, claims, and accompanying drawings of the embodiments of this application, terms “first,” “second,” and the like are intended to distinguish between different objects but do not indicate a particular order. In addition, terms “include” and any variations thereof are intended to cover non-exclusive inclusion. For example, a process, a method, an apparatus, a product, or a device that includes a series of operations or units is not limited to the listed operations or units; and instead, further exemplarily includes an operation or a unit that is not listed, or further exemplarily includes another operation or unit that is intrinsic to the process, method, apparatus, product, or device.

A person of ordinary skill in the art may be aware that, in combination with examples of units and algorithm operations described in the embodiments disclosed in this specification, this application may be implemented by using electronic hardware, computer software, or a combination thereof. To clearly describe interchangeability between the hardware and the software, compositions and operations of each example have been generally described according to functions in the foregoing descriptions. Whether the functions are executed in a mode of hardware or software depends on particular applications and design constraint conditions of the technical solutions. A person skilled in the art may use different methods to implement the described functions for each particular application, but it is not to be considered that the implementation goes beyond the scope of this application.

The method and relevant apparatus provided in the embodiments of this application are described with reference to method flowcharts and/or schematic structural diagrams provided in the embodiments of this application. Specifically, each procedure and/or each block in the method flowcharts and/or schematic structural diagrams and a combination of a procedure and/or a block in the flowcharts and/or block diagrams may be implemented through computer program instructions. These computer program instructions may be provided for a general-purpose computer, a dedicated computer, an embedded processor, or a processor of another programmable blockchain-based transaction management device to generate a machine, so that an apparatus for implementing a specific function in one or more procedures in the flowcharts or in one or more blocks in the schematic structural diagrams is generated through the instructions executed by the computer or the processor of another programmable blockchain-based transaction management device. These computer program instructions may also be stored in a computer-readable memory that can guide a computer or another programmable blockchain-based transaction management device to work in a specific manner, so that the instructions stored in the computer-readable memory generate a product including an instruction apparatus, where the instruction apparatus implements functions specified in one or more procedures in the flowcharts and/or one or more blocks in the schematic structural diagrams. These computer program instructions may also be loaded onto a computer or another programmable blockchain-based transaction management device, so that a series of operations and steps are performed on the computer or the another programmable blockchain-based management device, thereby generating computer-implemented processing. Therefore, the instructions executed on the computer or the another programmable blockchain-based management device provide operations for implementing a specific function in one or more procedures in the flowcharts and/or in one or more blocks in the schematic structural diagrams.

A sequence of the operations of the method in the embodiments of this application may be adjusted, and certain operations may also be combined or removed according to an actual requirement.

The modules in the apparatus in the embodiments of this application may be combined, divided, and deleted according to an actual requirement.

What is disclosed above is merely exemplary embodiments of this application, and certainly is not intended to limit the protection scope of this application. Therefore, equivalent variations made in accordance with the claims of this application shall fall within the scope of this application.

What is claimed is:

1. A blockchain-based transaction management method comprising:
obtaining transaction data;
generating a Merkle management tree based at least on the transaction data;
invoking a privacy contract based on privacy transaction data in the transaction data, and verifying a data execution state of the privacy transaction data through the privacy contract; and
generating a transaction block based on the Merkle management tree and the transaction data, and performing on-chain processing on the transaction block.

2. The method according to claim 1, further comprising:
in response to the data execution state being a data executable state, executing a privacy transaction corresponding to the privacy contract.

3. The method according to claim 1,
wherein the transaction data further includes regular transaction data other than the privacy transaction data;
the method further comprising:
obtaining the regular transaction data from the transaction data;
wherein generating the Merkle management tree includes generating the Merkle management tree based on the transaction data and a regular transaction corresponding to the regular transaction data.

4. The method according to claim 3, wherein:
the Merkle management tree includes a transactions tree, a receipts tree, and a world state tree; and
generating the Merkle management tree based on the transaction data and the regular transaction includes:
generating the transactions tree based on the transaction data;
obtaining privacy on-chain data corresponding to the privacy transaction data;
obtaining regular transaction information generated by executing the regular transaction corresponding to the regular transaction data;
obtaining regular account information corresponding to the regular transaction data;
constructing the receipts tree based on the privacy on-chain data and the regular transaction information; and
constructing the world state tree based on the privacy on-chain data and the regular account information.

5. The method according to claim 4, wherein:
obtaining the regular transaction information includes:
invoking, through the regular transaction data, a regular smart contract corresponding to the regular transaction data;
executing, through the regular smart contract, the regular transaction corresponding to the regular transaction data, to obtain a regular transaction execution result; and
obtaining regular log information generated in the execution process of the regular transaction;
wherein the regular transaction information includes the regular transaction execution result and the regular log information; and
obtaining the regular account information includes:
updating, based on the regular transaction, a transaction count of a regular account corresponding to the regular smart contract; and
generating a regular transaction hash based on the transaction count;
wherein the regular account information includes the regular transaction hash and account data of the regular account.

6. The method according to claim 1, wherein invoking the privacy contract and verifying the data execution state includes:
invoking a proxy contract based on the privacy transaction data;
transferring a transaction encryption parameter and a transaction parameter signature to the proxy contract, the transaction parameter signature being obtained by signing the transaction encryption parameter with a private key of a participating object;
decrypting, through the proxy contract, the transaction encryption parameter by using a private key of a target node that obtains the transaction data, to obtain a transaction parameter;
invoking the privacy contract through the proxy contract, and transferring the transaction parameter to the privacy contract; and
verifying the transaction parameter signature through the privacy contract, including:
in response to success of the verification on the transaction parameter signature, determining the data execution state of the privacy transaction data as the data executable state; or
in response to failure of the verification on the transaction parameter signature, determining the data execution state of the privacy transaction data as a data non-executable state.

7. The method according to claim 1, wherein generating the transaction block and performing on-chain processing on the transaction block includes:
generating the transaction block based on the Merkle management tree and the transaction data, and broadcasting the transaction block to a consensus node;
receiving a consensus-pending transaction block transmitted by the consensus node;
comparing the transaction block with the consensus-pending transaction block, to obtain a consensus result;
broadcasting the consensus result to the consensus node, to cause the consensus node to perform on-chain processing on the consensus-pending transaction block in response to detecting that consensus on the consensus-pending transaction block has been reached; and
performing on-chain processing on the transaction block in response to the consensus node having reached consensus on the transaction block.

8. The method according to claim 1, further comprising:
generating a data encryption key;
encrypting the privacy contract by using the data encryption key, to obtain an encrypted privacy contract;
encrypting the data encryption key by using a public key of the target node, to generate key protection data;
generating a contract signature for the encrypted privacy contract and the key protection data by using a private key of a participating object;
transmitting the encrypted privacy contract, the key protection data, and the contract signature to the proxy contract; and
deploying the privacy contract through the proxy contract, the encrypted privacy contract, the key protection data, and the contract signature.

9. The method according to claim 8, wherein deploying the privacy contract includes:
verifying the contract signature, and in response to the participating object being a privacy account, decrypting the key protection data by using the private key of the target node, to obtain the data encryption key; and
decrypting the encrypted privacy contract by using the data encryption key, to obtain the privacy contract, and deploying the privacy contract.

10. The method according to claim 9, further comprising:
in response to a privacy account registration request, verifying, through the proxy contract, a registration signature carried in the privacy account registration request, the registration signature being generated with the private key of the participating object;
in response to success of the verification on the registration signature, updating an account registration state for the privacy account registration request to a confirmation pending state, and forwarding the privacy account registration request to a management device, to cause the management device to return an account registration confirmation message after successfully verifying the privacy account registration request;
verifying, through the proxy contract, a registration management signature carried in the account registration confirmation message, and in response to success of the verification on the registration management signature, updating the account registration state to a confirmed state; and
determining the participating object as the privacy account based on the account registration state.

11. The method according to claim 1, further comprising:
constructing a contract deployment function, a contract invocation function, and a privacy account management function, integrating the contract deployment function, the contract invocation function, and the privacy account management function into contract code to generate the proxy contract, and deploying the proxy contract;
wherein invoking the privacy contract and verifying the data execution state of the privacy transaction data includes:
invoking the proxy contract through the privacy transaction data, and determining, in the proxy contract, the privacy contract corresponding to the privacy transaction data; and
invoking the contract invocation function in the proxy contract, invoking the privacy contract by using the contract invocation function, and verifying the data execution state of the privacy transaction data through the privacy contract.

12. The method according to claim 1, further comprising:
obtaining privacy transaction information generated by the privacy transaction;
generating a privacy block based on the privacy transaction information; and
adding the privacy block to a privacy blockchain.

13. The method according to claim 1, further comprising:
obtaining privacy transaction information generated by the privacy transaction;
obtaining a privacy data identifier corresponding to the privacy transaction data in the Merkle management tree; and
storing the privacy data identifier and the privacy transaction information in association.

14. A computer device comprising:
a processor; and
a memory storing a computer program that, when executed by the processor, causes the computer device to:
obtain transaction data;
generate a Merkle management tree based at least on the transaction data;
invoke a privacy contract based on privacy transaction data in the transaction data, and verify a data execution state of the privacy transaction data through the privacy contract; and
generate a transaction block based on the Merkle management tree and the transaction data, and perform on-chain processing on the transaction block.

15. The computer device according to claim 14, wherein the computer program further causes the computer device to:
in response to the data execution state being a data executable state, execute a privacy transaction corresponding to the privacy contract.

16. The computer device according to claim 14, wherein:
the transaction data further includes regular transaction data other than the privacy transaction data; and
the computer program further causes the computer device to:
obtain the regular transaction data from the transaction data; and
generate the Merkle management tree based on the transaction data and a regular transaction corresponding to the regular transaction data.

17. The computer device according to claim 16, wherein:
the Merkle management tree includes a transactions tree, a receipts tree, and a world state tree; and
the computer program further causes the computer device to, when generating the Merkle management tree based on the transaction data and the regular transaction:
generate the transactions tree based on the transaction data;
obtain privacy on-chain data corresponding to the privacy transaction data;
obtain regular transaction information generated by executing the regular transaction corresponding to the regular transaction data;
obtain regular account information corresponding to the regular transaction data;
construct the receipts tree based on the privacy on-chain data and the regular transaction information; and
construct the world state tree based on the privacy on-chain data and the regular account information.

18. The computer device according to claim 17, wherein the computer program further causes the computer device to:
when obtaining the regular transaction information:
invoke, through the regular transaction data, a regular smart contract corresponding to the regular transaction data;
execute, through the regular smart contract, the regular transaction corresponding to the regular transaction data, to obtain a regular transaction execution result; and
obtain regular log information generated in the execution process of the regular transaction;
wherein the regular transaction information includes the regular transaction execution result and the regular log information; and
when obtaining the regular account information:
update, based on the regular transaction, a transaction count of a regular account corresponding to the regular smart contract; and
generate a regular transaction hash based on the transaction count;
wherein the regular account information includes the regular transaction hash and account data of the regular account.

19. The computer device according to claim 14, wherein the computer program further causes the computer device to, when invoking the privacy contract and verifying the data execution state:
invoke a proxy contract based on the privacy transaction data;
transfer a transaction encryption parameter and a transaction parameter signature to the proxy contract, the transaction parameter signature being obtained by signing the transaction encryption parameter with a private key of a participating object;
decrypt, through the proxy contract, the transaction encryption parameter by using a private key of a target node that obtains the transaction data, to obtain a transaction parameter;
invoke the privacy contract through the proxy contract, and transferring the transaction parameter to the privacy contract; and
verify the transaction parameter signature through the privacy contract, including:
in response to success of the verification on the transaction parameter signature, determining the data execution state of the privacy transaction data as the data executable state; or
in response to failure of the verification on the transaction parameter signature, determining the data execution state of the privacy transaction data as a data non-executable state.

20. Anon-transitory computer-readable storage medium storing a computer program that, when executed by a processor, causes a computer device including the processor to:
obtain transaction data;
generate a Merkle management tree based at least on the transaction data;
invoke a privacy contract based on privacy transaction data in the transaction data, and verify a data execution state of the privacy transaction data through the privacy contract; and
generate a transaction block based on the Merkle management tree and the transaction data, and perform on-chain processing on the transaction block.
